(19) United States
(12) Patent Application Publication
(10) Pub. No.: US 2025/0104505 A1
(43) Pub. Date: Mar. 27, 2025

(54) GAMING DEVICE WITH QUALIFIER SYMBOL LINKED GAME EVENTS AND METHODS OF PERFORMING THE SAME

(71) Applicant: Aristocrat Technologies Australia Pty Limited, North Ryde (AU)

(72) Inventors: Joshua Matos, Cordeaux Heights (AU); Antoon Visser, Coogee (AU); Karen Kendall, Toongabbie (AU)

(21) Appl. No.: 18/430,417

(22) Filed: Feb. 1, 2024

(30) Foreign Application Priority Data
Sep. 25, 2023 (AU) 2023233280

(51) Int. Cl. G07F 17/32; G06F 7/58

(52) U.S. Cl. CPC G07F 17/3213; G06F 7/588; G07F 17/3267

(57) ABSTRACT

An electronic gaming device is provided. The electronic gaming device may include a memory storing reel data defining a plurality of reel strips, each reel strip being associated with a respective one of a plurality of columns of symbol positions. The electronic gaming device may be configured to select, using a random number generator, symbols from a first reel strip and second reel strip for each symbol position of a first column and second column of symbol positions each having a base number of symbol positions, and upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions.

### CROSS-REFERENCE TO RELATED APPLICATIONS

This application claims the benefit of Australian Patent Application No. 2023-233280, filed Sep. 25, 2023, and entitled “GAMING DEVICE WITH QUALIFIER SYMBOL LINKED GAME EVENTS,” the contents and disclosures of which are hereby incorporated in their entirety.

### FIELD

The present application relates to an electronic gaming device, a method of operating an electronic gaming device and a computing system configured to perform certain game operations or game events in response to certain qualifier symbols being displayed within the game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

### SUMMARY

In one aspect, an electronic gaming device is provided. The electronic gaming device may include at least one processor and at least one memory storing (1) reel data defining a plurality of reel strips, each reel strip associated with a respective one of a plurality of columns of symbol positions and (2) instructions which, when executed by the processor, may cause the processor to select, using a random number generator, symbols from a first reel strip for each symbol position of a first column of symbol positions having a base number of symbol positions, select, using the random number generator, symbols from a second reel strip for each symbol position of a second column of symbol positions having the base number of symbol positions, upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions, select, using the random number generator, symbols from at least a third reel strip for each symbol position of a corresponding at least a third column of symbol positions, the at least a third column having the set number of symbol positions, and cause to display on a display device the plurality of columns of symbol positions including the selected symbols.

In another aspect, a computer system is provided. The computer may include at least one processor in communication with at least one gaming device and at least one memory storing (1) reel data defining a plurality of reel strips, each reel strip associated with a respective one of a plurality of columns of symbol positions and (2) instructions which, when executed by the processor, may cause the processor to select, using a random number generator, symbols from a first reel strip for each symbol position of a first column of symbol positions having a base number of symbol positions, select, using the random number generator, symbols from a second reel strip for each symbol position of a second column of symbol positions having the base number of symbol positions, upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions, select, using the random number generator, symbols from at least a third reel strip for each symbol position of a corresponding at least a third column of symbol positions, the at least a third column having the set number of symbol positions, and cause to display on the at least one gaming device the plurality of columns of symbol positions including the selected symbols.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIG. 6 is an example screen display of an example game that includes qualifier symbols being displayed that trigger certain game operations during game play in accordance with the present disclosure.

FIG. 7 is another example screen display of an example game that includes qualifier symbols being displayed that trigger certain game operations during game play in accordance with the present disclosure.

FIG. 8 is another example screen display of an example game that includes qualifier symbols being displayed that trigger certain game operations during game play in accordance with the present disclosure.

FIG. 9 is another example screen display of an example game that includes qualifier symbols being displayed that trigger certain game operations during game play in accordance with the present disclosure.

FIG. 10 is another example screen display of an example game that includes qualifier symbols being displayed that trigger certain game operations during game play in accordance with the present disclosure.

FIG. 11 is another example screen display of an example game that includes qualifier symbols being displayed that trigger certain game operations during game play in accordance with the present disclosure.

FIG. 12 is another example screen display of an example game that includes qualifier symbols being displayed that trigger certain game operations during game play in accordance with the present disclosure.

FIG. 13 is another example screen display of an example game that includes qualifier symbols being displayed that trigger certain game operations during game play in accordance with the present disclosure.

FIG. 14 is another example screen display of an example game that includes qualifier symbols being displayed that trigger certain game operations during game play in accordance with the present disclosure.

### DETAILED DESCRIPTION

There is disclosed a gaming device, a method of operating a gaming device and a computer system configured to cause one or more qualifier symbols to be displayed, wherein those qualifier symbols are linked to certain game events that may occur during gameplay. The gaming device may display a game matrix including a plurality of columns (e.g., five columns), each including a base number of symbol positions (e.g., four symbol positions). The gaming device may include a memory for storing reel data defining a plurality of reel strips each associated with a respective one of the columns. During gameplay, the gaming device may select a symbol to display in each of the symbol positions based on the stored reel strip associated with each column and a corresponding RNG call.

In the example embodiment, a qualifier symbol may be selected for display, for example, in a first column of symbol positions. When the qualifier symbol, or some predefined combination of qualifier symbols, is selected and displayed, game events may occur depending on the outcomes of symbol selections in the other displayed columns, for example (i) an increase in the number of symbol positions in one or more other columns; (ii) an award of credit values on displayed symbols; and (iii) triggering of a feature game. For example, in some embodiments, if the qualifier symbol is displayed in one of the first two columns, an RNG call may be triggered to determine whether and/or how many additional symbol positions to add to one or more of the remaining columns. This may occur while the remaining symbol positions are still spinning. The gaming device may add these positions to the display before selecting symbols to display in the symbol positions of the remaining columns. If the qualifier symbols land on subsequent reels, further growth may be triggered in a similar manner.

The embodiments of the present disclosure represent a technical improvement in the art of electronic gaming devices, machines, systems, and operations of such electronic gaming devices or systems. Technical improvements represented by the present disclosure include at least using an RNG to randomly determine symbols for displaying in each symbol position during a game instance and evaluating for one or more winning combinations to award a player, for triggering a modification to the game display (e.g., column growth) based on a predefined qualifying symbol being displayed, for determining whether and how many symbol positions to add to certain columns of the game display when column growth is triggered, and triggering an immediate credit award and/or a feature game based on a predefined qualifying symbol being displayed. During a game instance, one or more RNG calls are used to determine symbols to display in respective symbol positions, which may in some instances include a qualifying symbol that triggers game display modification (e.g., column growth). Once it is determined that the display should be modified by adding symbol positions to certain columns (e.g., a predefined set of columns and/or those columns subsequent or to the right of where the qualifying symbol is displayed), the system may determine whether to add at least one symbol to these positions, and if so, how many symbol positions to add, based on an additional RNG call. Thus, both the prerequisite condition for column growth (i.e., an appearance of the qualifying symbol) and the amount by which each column may be expanded may be determined randomly.

Accordingly, this feature may increase the degree of randomness in a displayed output. Further, randomizing these aspects of the display may allow a smaller set of reel data and payline pathways to be stored within memory to achieve a greater number of potential display and reward outcomes. In other words, this added randomness, which increases the number of potential display and reward outcomes, may be implemented without a need for storage of additional reel data (e.g., data other than the reel strip stored for each column) and payline data since the additional symbols are already included on the reels and it is merely a matter of expanding the displayed symbol positions.

The technical problems addressed herein include at least one of: (i) inability of known systems to determine when to expand certain columns of an electronic game display; (ii) inability of known systems to determine, when a column expansion feature is triggered, how to determine whether and by how many symbol positions to expand the column; (iii) inability of known systems to independently determine, when a column expansion feature is triggered, how to determine whether and by how many symbol positions to expand each column; and (iv) inability of known systems to improve a randomness of display and award outcomes without increasing data storage and use of computation resources.

The resulting technical effects and/or technical benefits achieved by this disclosure include at least one of: (i) ability to determine when to expand certain columns of an electronic game display by using one or more RNG calls to determine where to display reel symbols for each column and triggering the column expansion based on an appearance of one or more, or a certain combination of, qualifying symbols; (ii) ability to determine, when a column expansion feature is triggered, whether and by how many symbol positions to expand the column using one or more RNG calls; (iii) ability to determine, when a column expansion feature is triggered, whether and by how many symbol positions to expand each column by performing a separate RNG call for each column; and (iv) improvement of randomness of display and award outcomes without increasing data storage and use of computation resources by using one or more respective RNG calls to determine when to trigger a column expansion feature and whether and by how many symbol positions to expand each column.

Various interface improvements are provided herein to efficiently and effectively communicate information. For instance, while advancement toward and during play of a number of free games, as described herein, various animations are provided to communicate incrementation of award win symbols, accumulation of award value, and a status of the advancement toward the number of free games (e.g., a number of spins remaining in the hold and spin game before the free games are provided).

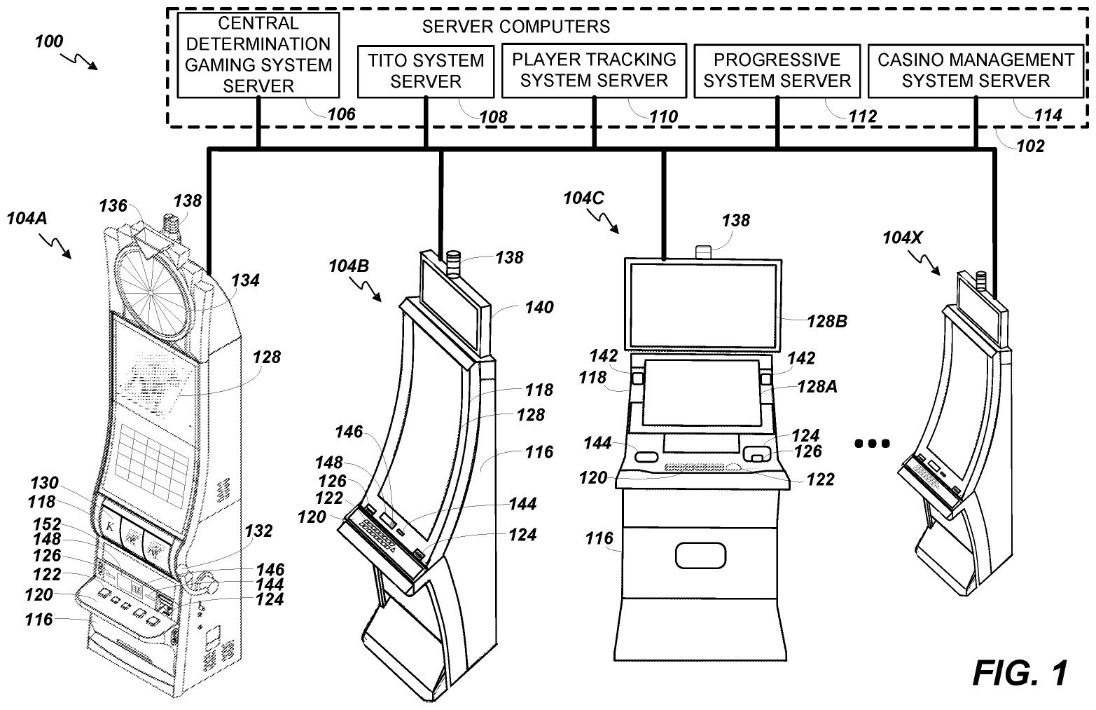

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

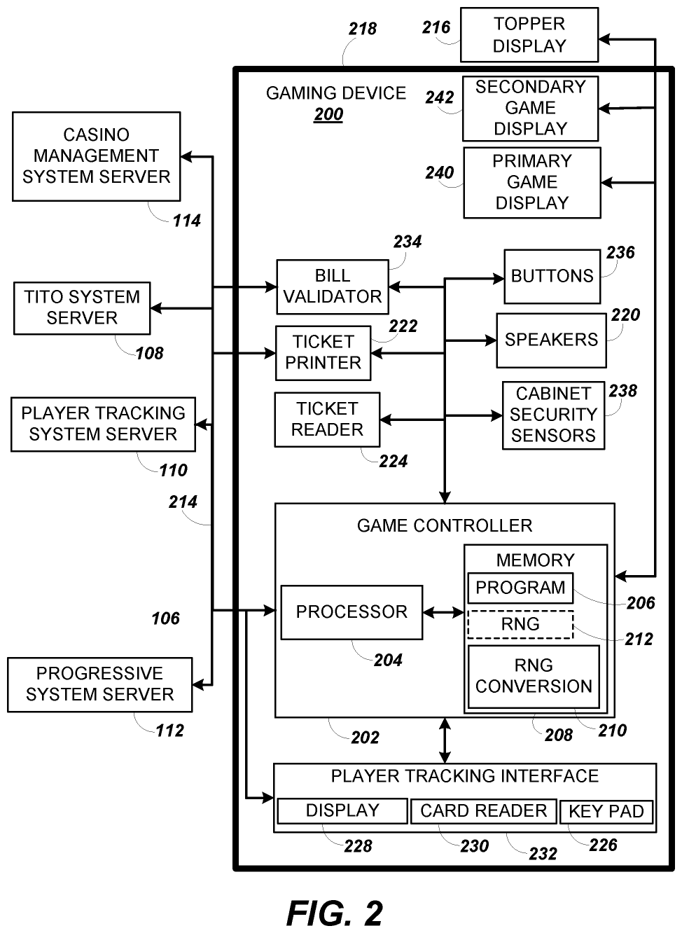

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

An example method of operating an EGM broadly involves conducting a base game in response to receipt of a wager by selecting symbols from reel strips, evaluating the selected symbols, and conducting a feature game if one is triggered.

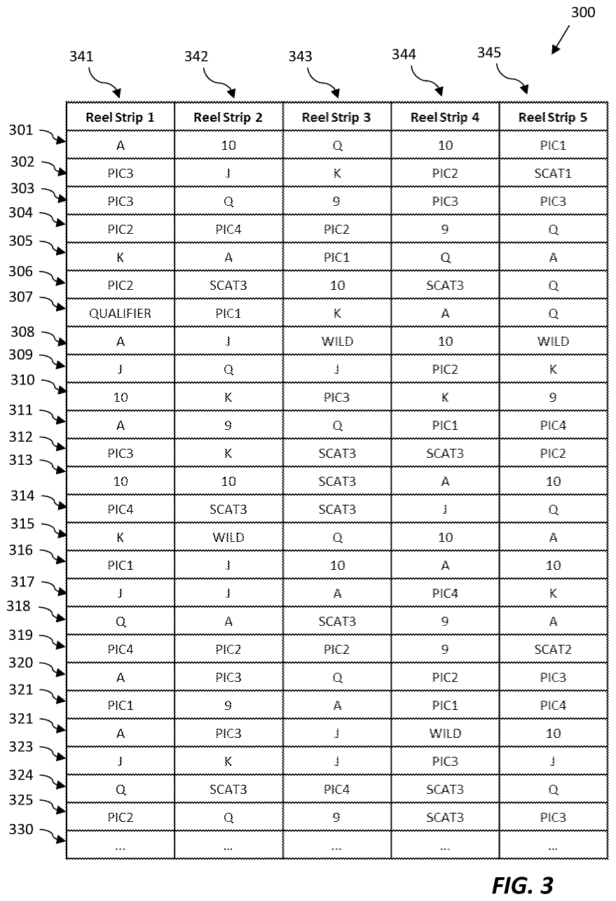

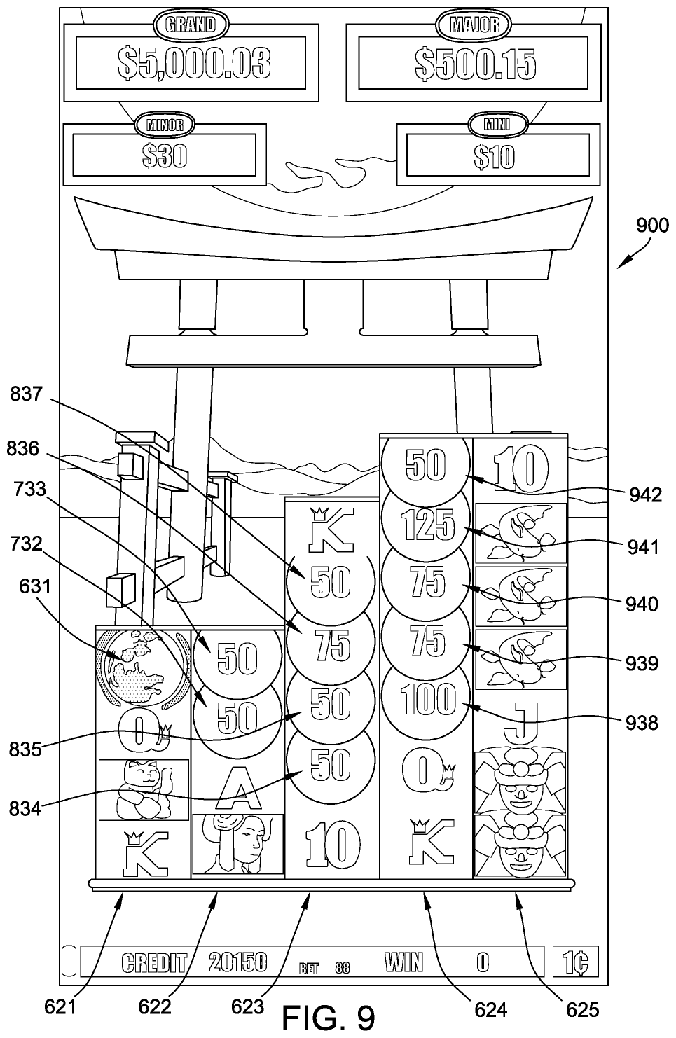

FIG. 3 shows example reel strips that illustrate the make-up of reel strips used in the base game. FIG. 3 illustrates an example of a set 300 of five reel strips 341, 342, 343, 344, 345. In the example, for illustrative purposes, twenty-five reel strip positions 301-325 are shown for each reel strip 341-345. Each reel strip position of each reel has a symbol. For example, a “PIC1” symbol occupies the twenty-first reel strip position 321 of the fourth reel 344. The symbols shown on the reel strip are generally indicative of symbols that may be employed in the embodiments, however, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, reel strips 321-325 may have larger stacks of SCAT3 symbols (see for example, FIG. 9). In some examples, the reel strips associated with different columns may be of different lengths to one another.

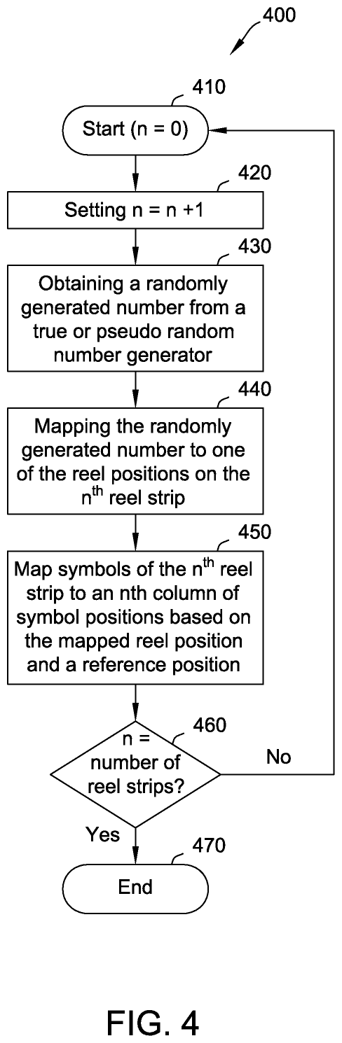

FIG. 4 is a flow chart of a general form of an example method 400 carried out by processor 204 to select symbols from r reel strips for r columns—for example, five reel strips/columns. In an embodiment, this process 400 applies in the feature games but is modified in the base game to advantageously enable dynamic changes to a number of symbols selected as explained further below.

In the example method shown in FIG. 4, at step 410, processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, processor 204 maps symbols of the nth reel strip to an nth column of symbol display positions based on the mapped reel position and a reference position. In an example, the reference position is the bottom position of the symbol positions of each column of symbol positions. Thus, in this example, the selected reel position (and hence the symbol at this position) is mapped to the bottom symbol position of the column and reel positions “above” the selected reel positions are mapped to symbol positions above the bottom symbol position in order to populate all symbol positions of the column. Referring to the example reel strips of FIG. 3, if the value returned by the RNG 212 is mapped to reel position 313 when four symbols are being selected for a first column of symbol positions then for the first reel strip 341, “10” is mapped to a first, bottom symbol position, “PIC3” symbol is mapped to a second symbol position, “A” symbol is mapped to a third symbol position, and “10” symbol is mapped to a fourth, top symbol position.

In this example, the number of symbol positions in some of the columns is dynamic, and hence, the number of symbols that are mapped from the reel strip is also dynamic for those columns as explained further below.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470.

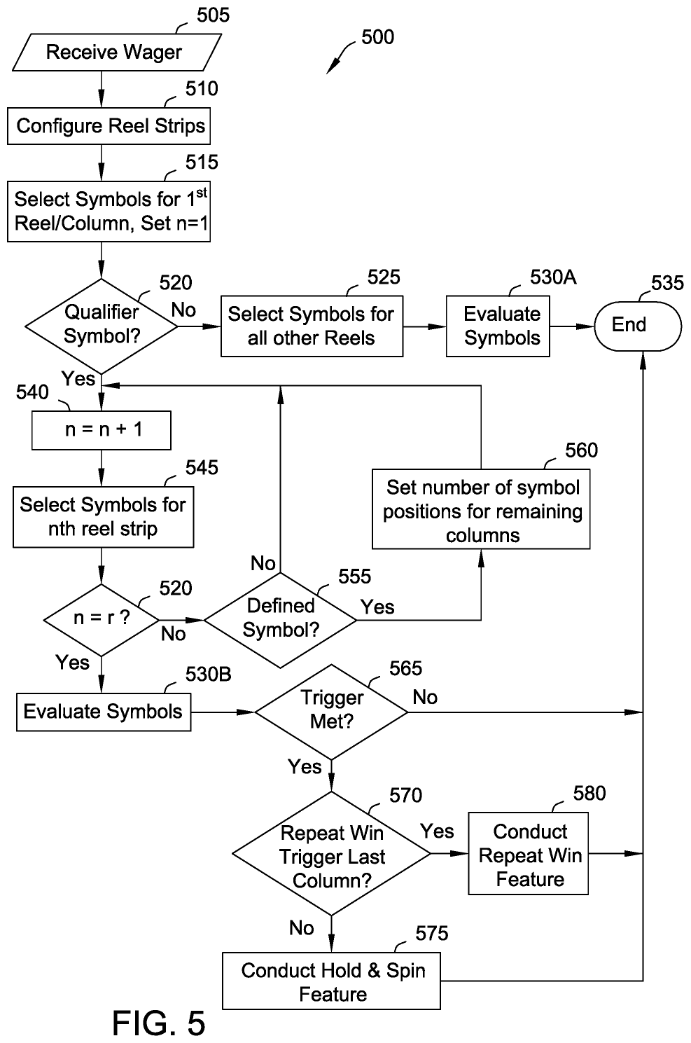

FIG. 5 is a flow chart of an example embodiment of a method 500 of operating a gaming device 200. At step 505, processor 204 initiates a base game instance in response to receiving a wager.

At step 510, processor 204 configures the reel strips for a current game instance. As shown in FIG. 3, in this example, reel strips 341-345 have SCAT3 symbols (e.g. at the sixth reel strip position 306 of second reel strip 342. The SCAT3 symbols that are independently configured in each game instance to have one of a credit prize symbol (e.g. a credit value), a bonus prize symbol (e.g. Mini Bonus, Minor Bonus), jackpot prize symbol (e.g. Major Jackpot, Grand Jackpot), or jackpot chance symbol. In the configuration step 510, processor 204 uses random number generator 212 and a weight table in memory 208 to determine which of these symbols will be selected for a respective SCAT3 symbol.

Some embodiments incorporate a dynamic symbol selection process where outcomes of symbol selection in respect of columns of symbol positions can affect a number of symbol position for which symbols are selected in subsequent columns of symbol positions. Advantageously, this provides an opportunity for one or more of the columns of symbol positions to grow within the symbol selection process.

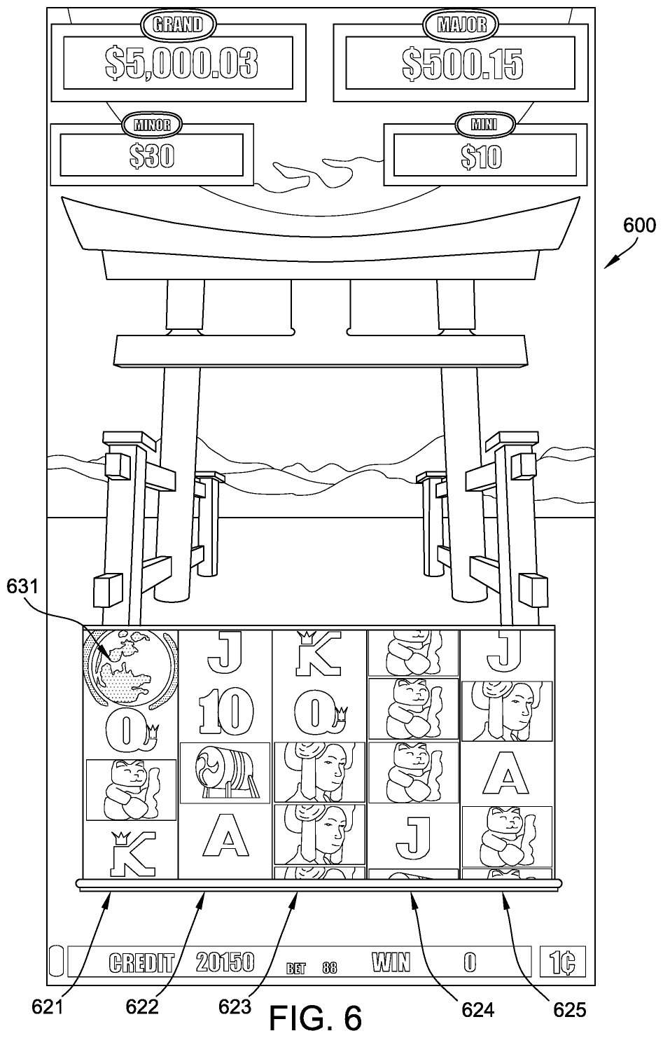

At step 515, processor 204 selects symbols from a first reel strip (or reel) 321 for a first column 621 of symbol positions and sets a reel/column counter to one. To select symbols, processor 204 implements steps 430-450 of FIG. 4 with the mapping step 450, mapping four symbols of the first reel strip to the first column of symbol positions. FIG. 6 shows an example screen display 600 of an example, of base game showing an example where processor 204 has controlled the first reel strip to stop at the selected stopping position for the first column while the other reels corresponding to the other columns of symbol positions 622-625 are displayed as continuing to spin. As shown in FIG. 6, initially a base number of four symbol positions are displayed for each column 621-625 but as explained below some of the columns of symbol positions can grow to have more symbol positions, in an example to as many as ten symbol positions. That is, the base number of symbol positions is the minimum number of symbol positions for a respective column or the number of symbol positions of a column for which symbols will be selected if the columns do not grow.

In this example, the symbols selected by processor 204 for first column 621 include QUALIFIER symbol 631, here in the form of a red moon symbol. As will be explained below, the red moon symbol is a defined symbol that is termed a qualifier symbol as its selection is a precondition not only for column growth but also for triggering other game events including the feature games. Advantageously, QUALIFIER symbol provides a clear visual indication to the player that a game outcome that is being displayed qualifies for additional game events, in this example, reel growth, an award of prize values on symbols, and feature games. QUALIFIER symbol may incorporate a multiplier e.g. a ×2, ×3, ×5 or ×10 multiplier. The QUALIFIER symbol 631 of FIG. 6 has no multiplier.

At step 520, processor 204 determines whether the selected symbols include the QUALIFIER symbol. If processor 204 makes a negative determination, processor 204 proceeds to step 525 and selects symbols for all other reel strips/columns using the process of FIG. 4 with four symbols being mapped for each reel strip until all reel strips have been mapped to columns of symbol positions. After the symbols are selected, processor 204 evaluates the selected symbols at step 530A for one or more winning combinations based on a pay table stored in memory 208. In this example, processor 204 applies a ways to win evaluation by processing the selected symbols to identify instances of the same symbol appearing from left to right in neighboring columns. Upon there being one or more winning combinations, processor 204 makes an award for each winning combination based on any selected bet multiplier, for example, by adding credit amounts defined by the pay table to a meter such as a win or credit meter in memory 204. Then, at step 530, the game instance ends 530.

In the example of FIG. 6, processor 204 will make a positive determination at step 520 because QUALIFIER symbol 631 has been selected. Accordingly, processor 204 proceeds to step 540 and updates the current reel counter in memory 208 which in this iteration will be to a value of two. Then, at step 545, processor 204 selects symbols for the nth (here the 2^{nd}) reel strip, again using steps 430 to 450 of FIG. 4. At step 550, processor 204 determines whether the current value of n (here 2) equals the total number of reel strips (r). As r=5 in this example, in this iteration, processor 204 will make a negative determination at step 550 and proceed to step 555.

At step 555, processor 204 determines whether the symbols selected for a current column (in this iteration the second column 622) include a defined symbol. In this example, the defined symbol is a SCAT3 symbol.

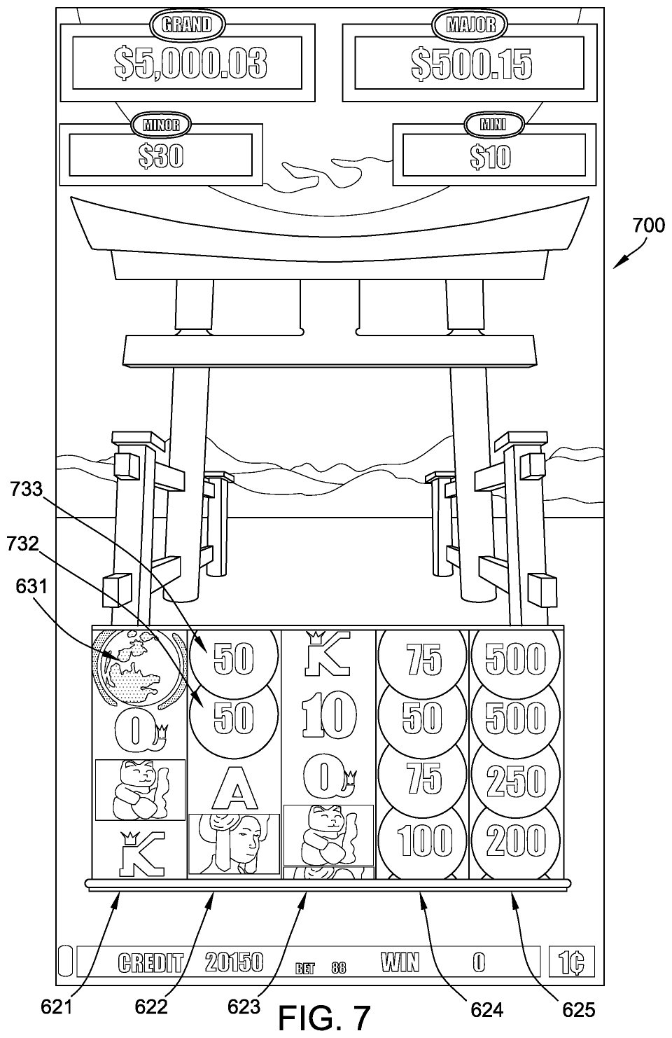

FIG. 7 is an example screen display 700 where processor 204 has selected at least one SCAT3 symbol for the second column 622 and controlled the reel strip of the second column to come to a stop while the other reel strips keep spinning. In this example, processor 204 has selected two SCAT3 symbols 732,733 each having a credit prize value of 50 credits. Accordingly, processor 204 will make a positive determination at step 555.

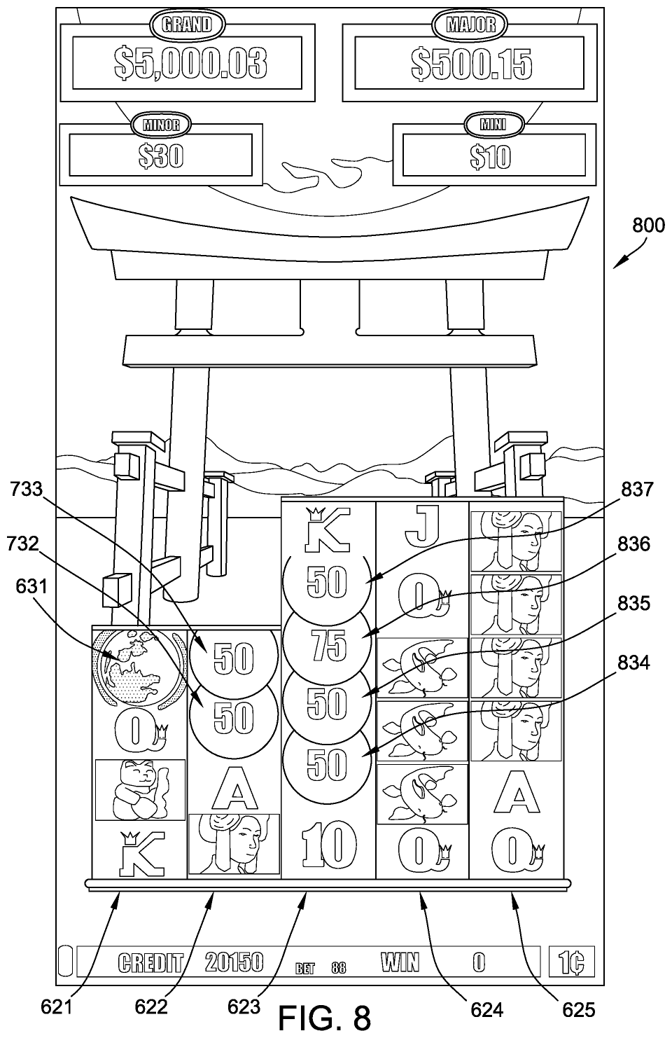

In this example, processor 204 then proceeds to step 560 and sets a minimum number of symbol positions for the remaining columns, here third to fifth columns 633-635 as shown in example screed display 800 of FIG. 8. In an example, processor 204 makes a random determination at step 560 as to whether to add 0, 1 or 2 symbol positions to the previously set number of symbol positions. In this iteration the previously set number of symbol positions is the base number of symbol positions, such that the possible outcomes of the setting step 560 are 4, 5, or 6 symbol positions as a current number of symbol positions. In this example, processor 204 makes the selection using a weight table in memory 208 and RNG 212. FIG. 8 shows an example where processor 204 has made a determination to add two symbol positions to each of the third column 623, fourth column 624 and fifth column 625 such that they each now have six symbol positions.

In other examples, processor 204 may add a fixed number of symbol positions (e.g. two) at step 560 upon making a positive determination at step 555.

In other examples, a positive determination at step 555 is followed by a random determination at step 560 as to whether to add 1 or 2 symbol positions so that at a minimum one symbol position will be added.

In examples where there is a maximum increase of two symbol positions, a maximum number of ten symbol positions is only achievable in the fifth column 625. Advantageously, this controls a number of ways to win to be within the range of 1024 (4⁵) to 7680 (4×4×6×8×10).

In other examples, there may be a larger range of symbol positions that may be added to a column, such that there is a chance that more than one column reaches maximum size. It will be appreciated that in such an example, the process 500 at step 560 may be modified to enforce a cap on a number of symbol positions of a column. It will also be appreciated that this will increase the maximum number of ways to win which may require adjustment of the pay table.

After adding the symbol positions, processor 204 iterates to step 540 and increments the reel strip counter and then selects symbols for the nth reel strip which in this iteration will be the third reel strip. FIG. 8 shows the outcome of this selection process. It will be noted that in the mapping step of this iteration, six symbols from the fourth reel strip are mapped to the third column. In this example, four further SCAT3 symbols 834-837 having credit values of 50, 50, 75 and 50 credits have been selected in third column 623. As n (3)≠r(5), processor 204 will make a negative determination at step 550 followed by a positive determination at step 555. As shown in FIG. 9, in this example processor 204 has added one further symbol position at setting step 560 to fourth column 624 so that the current number of symbol positions is seven. Processor 204 has then iterated to step 540 and incremented the reel strip counter to four before selecting seven symbols from the fourth reel strip for fourth column 624 as shown in FIG. 9. It will be observed that in this example, processor 204 has selected a further five SCAT3 symbols 938-942 having credit values of 100, 75, 75, 125 and 50 credits. Accordingly, processor 204 will iterate again to step 560. It will also be appreciated that other outcomes of the setting step in this iteration could have resulted in the current number of symbol positions becoming eight symbol positions or remaining at the previously set number of six symbol positions.

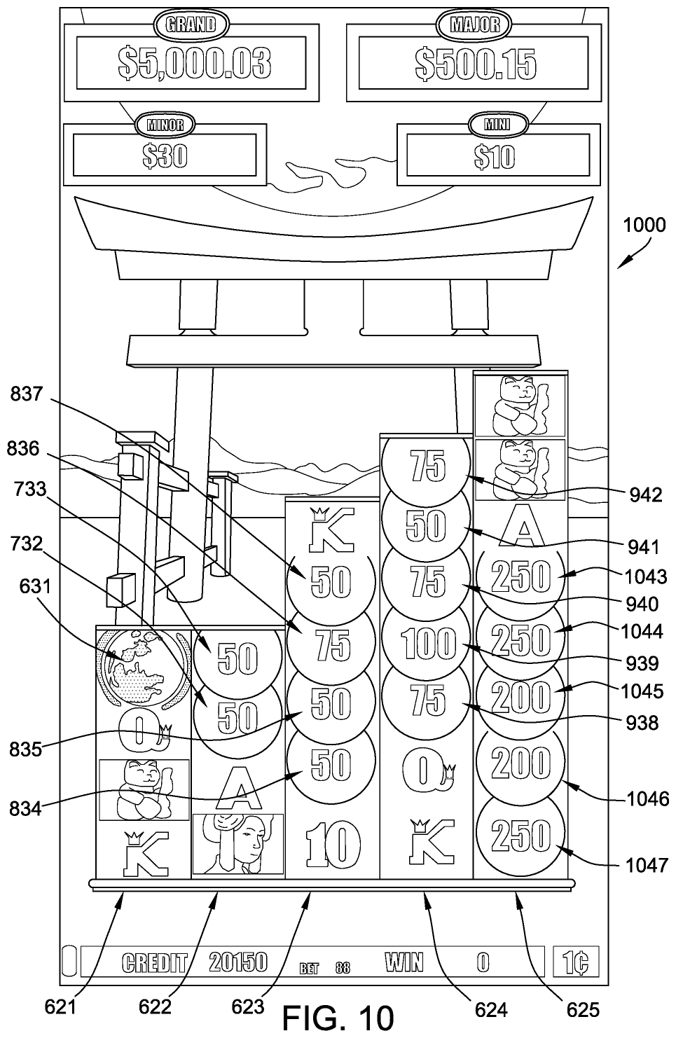

FIG. 10 shows a further example screen display after processor 204 has iterated through steps 560, 540 and 545 and added one more symbol position to fifth column such that it now has eight symbol positions. As shown in processor 204 has selected a further five SCAT3 symbols 1043-1047 having credit values of 250, 200, 200, 250 and 250 credits in fifth column 625.

It will be apparent from the above description that the setting process happens for each column where the preconditions for reel growth are met such that the height of a specific column can be set multiple times. For example, in the example of FIGS. 8 to 10, the first column 625 has its height set to a new number of symbol positions three times. In this iteration, processor 204 will make a positive determination at step 550 because symbols have been selected from all reel strips for all columns and will proceed to step 530B and evaluate the symbols. In this example, evaluation of the symbols also comprises, when a QUALIFIER symbol is selected, awarding all values shown on SCAT3 symbols multiplied by any multiplier shown on the QUALIFIER symbol. Accordingly, in FIG. 10 evaluation of the symbols will include making an award of the total of the values shown on all of the SCAT3 symbols 732,733,834-837,938-942,1043-1047 which is 1850 credits.

At step 565, processor 240 determines whether a trigger condition is met. In the case of FIG. 10, as explained further below, processor 204 will make a negative determination at step 565 and the process will end at step 535.

In the example process 500 of FIG. 5, a defined symbol does not have to appear in each column for there to be growth in the number of symbol positions in a column. For example, if no SCAT3 symbols were selected for third column, then fourth column 624 would not grow but there would still be a chance of fifth column 625 growing. In another example, process 500 may be modified so that there can be no further growth once any individual column does not have a defined symbol selected for it.

It will be appreciated that in some examples, the above-described symbol selection and column growth processes are implemented by processor 204 prior to any selected symbols being displayed on display 240.

Embodiments of the invention employ at least three different defined symbols in a trigger mechanic for feature games that is integrated with the use of the QUALIFIER symbol to award other game events and the award of prize values shown on SCAT3. As foreshadowed above, a first defined symbol is the QUALIFIER symbol 631. A second defined symbol is the SCAT3 symbol. As will be observed from the example of FIG. 10, in some examples, SCAT3 symbols are relatively common on reel strips 321-325 and are more likely to be selected as columns grow. Accordingly additional components are incorporated into the trigger mechanic including a requirement for another defined symbol to be selected in a specific column of symbol positions, in this example, fifth column 625.

In an example, the identity of the another defined symbol can determine which of a plurality for feature games are triggered. In this example, a third defined symbol (SCAT1) may be associated with a first feature game and a fourth defined symbol (SCAT2) is associated with a second feature game. In this example, another component of the trigger mechanism is that SCAT 3 symbols are required to be selected for at least the second to fourth columns.

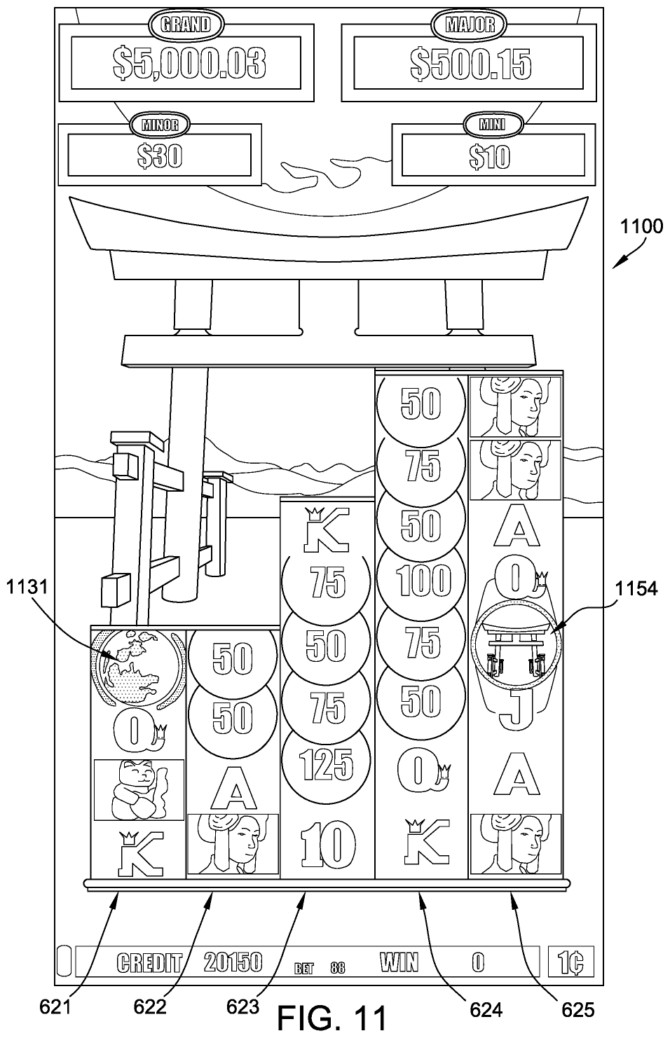

FIG. 11 is an example screen display 1100 of a trigger condition being met in respect of a first feature game, in this example a repeat win feature game. In this example, QUALIFIER symbol 1131 has been selected in first column, SCAT3 symbols have been selected in each of second to fourth columns 622-624, and SCAT1 symbol 1151 has been selected in fifth column 625. The trigger condition being met also results in an award of the credit amounts on the SCAT3 symbols, in this example, 825 credits.

It will be observed from screen display 1100 that the conditions for reel growth have been satisfied for the third, fourth and fifth columns 623-625. It will also be observed that this has resulted in processor 204 setting the third column 623 to be six symbol positions, the fourth column 624 to be eight symbol positions, and the fifth column 625 to be eight symbol positions—i.e. the setting process has not resulted in an increase in the number of symbol positions for the fifth column despite the pre-conditions being met because the random determination outcome was not to add a symbol position.

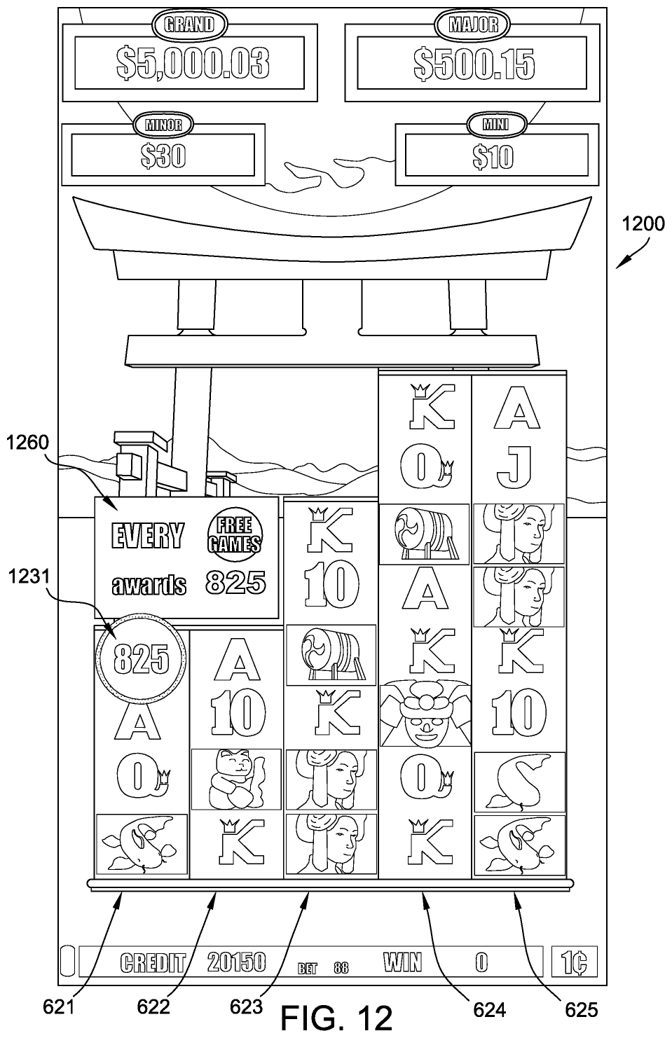

FIG. 12 is an example screen display 1200 of the repeat win feature game. In the repeat win feature a plurality of feature games are conducted using the state of the columns from the triggering base game. In the free games, the reel strips include REPEAT WIN symbols. In this example, REPEAT WIN symbol 1231 shares visual characteristics with SCAT1 symbol and also carries a prize value corresponding to the award for SCAT2 symbols from the base game, here 825 credits. As indicated by game message 1260, each time a REPEAT WIN symbol is selected during the free games it results in an award of 825 credits.

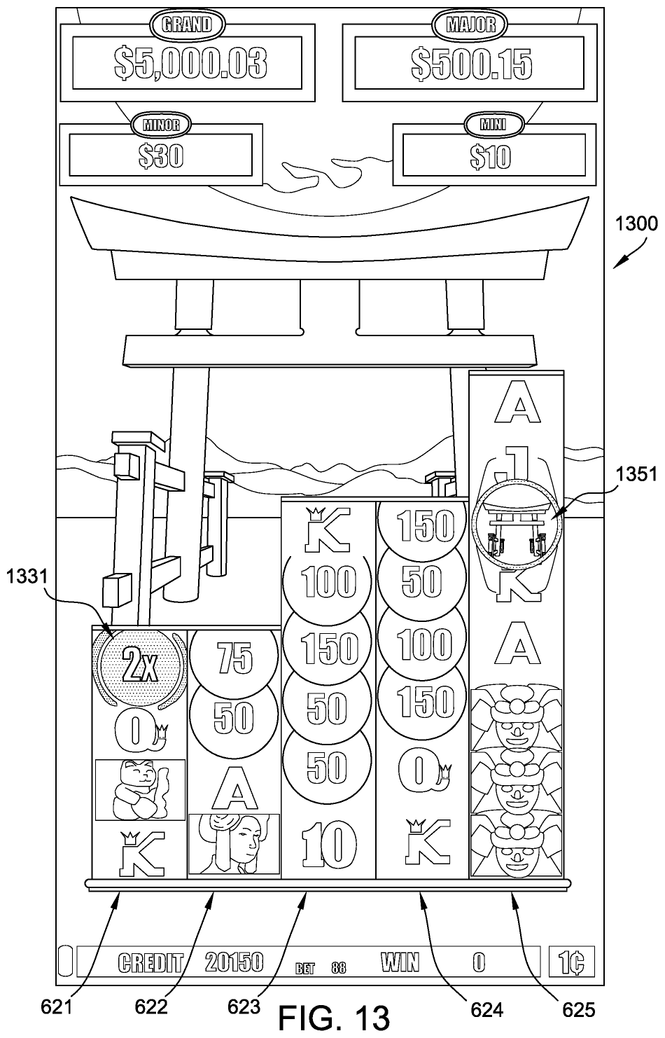

FIG. 13 is an example screen display 1300 of a trigger condition being met in respect of a second feature game, in this example, a hold and spin feature game. In this example, QUALIFIER symbol 1331 has been selected in first column, SCAT3 symbols have been selected in each of second to fourth columns 622-624, and SCAT2 symbol 1351 has been selected in fifth column 625.

It will also be observed from screen display 1300 that the conditions for reel growth have been satisfied for the third, fourth and fifth columns 623-625. It will be observed that this has resulted in processor 204 setting the third column 623 to be six symbol positions, the fourth column 624 to be six symbol positions, and the fifth column 625 to be eight symbol positions—i.e. the setting process has not resulted in an increase in the number of symbol positions for the fourth column despite the pre-conditions being met. It will also be observed that QUALIFIER symbol 1331 includes a ×2 multiplier.

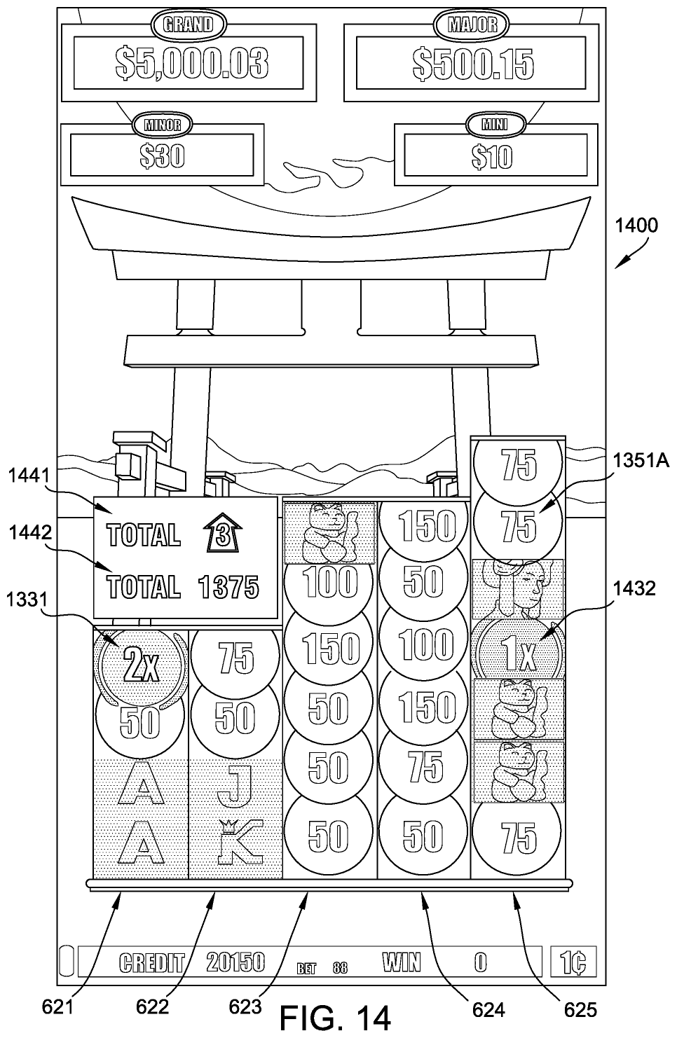

FIG. 14 is an example screen display 1400 from the hold and spin feature game. Again, in hold and spin feature the state of the columns from the triggering base game persist. In hold and spin game instances, the QUALIFIER symbol and each SCAT3 symbol is held from the triggering base game. The SCAT2 symbol is changed to a SCAT3 symbol 1351A with a randomly assigned value and also held.

During the hold and spin free games, symbol selection is performed by processor 204 using RNG 212 from reel strips having only the symbols QUALIFIER, SCAT3 or BLANK (i.e. no symbol at the reel strip position. Each selected QUALIFIER or SCAT3 is held at the position at which it is selected. Game instances are conducted until three consecutive games result in no QUALIFIER or SCAT3 being selected or QUALIFIER or SCAT3 being displayed at each symbol positions.

Processor 204 displays first game message 1441 which indicates a number of multipliers accrued, here showing a total of “3” reflecting the ×2 multiplier of QUALIFIER symbol 1331 and the ×1 multiplier of QUALIFIER symbol 1432. Processor 204 also displays second game message 1442 which indicates a current total of the credit values of the SCAT3 symbols.

At the end of the hold and spin feature, processor awards the total of credit values multiplies by the accrued multiplier by adding it to a win or credit meter in memory 208. In the example of FIG. 14, the award would be 3×1375=4125 credits.

### Example Embodiments

In an example embodiment, there is provided a gaming device comprising:
a display;
a random number generator;
a processor; and
a memory storing a memory storing (a) reel data defining five reel strips, each reel strip associated with a respective one of five columns of symbol positions, wherein the first reel strip comprises a first defined symbol, at least the second, third and fourth reel strips comprise a second defined symbol different to the first defined symbol, and the fifth reel strip comprises another defined symbol different to the first and second defined symbols, and (b) instructions which, when executed by the processor, cause the processor to:
   conduct a base game by selecting, using the random number generator symbols from to five reel strips for corresponding ones of the five columns; and
   initiate a feature game upon the selected symbols for the first to fifth columns including, the first, second and the another defined symbols.

In an embodiment when the instructions are executed by the processor, they cause the processor to upon the another defined symbol being a third defined symbol, initiate a first feature game, and upon the another defined symbol being a fourth defined symbol, initiate a second feature game.

In another embodiment, there is provided a method of operating a gaming device comprising a display, a random number generator, and memory storing reel data defining five reel strips, each reel strip associated with a respective one of five columns of symbol positions, wherein the first reel strip comprises a first defined symbol, at least the second, third and fourth reel strips comprise a second defined symbol different to the first defined symbol, and the fifth reel strip comprises another defined symbol different to the first and second defined symbols, the method comprising:
conducting a base game by selecting, using the random number generator symbols from to five reel strips for corresponding ones of the five columns; and
initiating a feature game upon the selected symbols for the first to fifth columns including, the first, second and the another defined symbols.

In another embodiment, there is provided a system comprising:
at least one display;
a random number generator;
one or more processors; and
memory (a) reel data defining five reel strips, each reel strip associated with a respective one of five columns of symbol positions, wherein the first reel strip comprises a first defined symbol, at least the second, third and fourth reel strips comprise a second defined symbol different to the first defined symbol, and the fifth reel strip comprises another defined symbol different to the first and second defined symbols, and (b) storing instructions which, when executed by the one or more processors, cause the one or more processors to:
conduct a base game by selecting, using the random number generator symbols from to five reel strips for corresponding ones of the five columns; and
   initiate a feature game upon the selected symbols for the first to fifth columns including, the first, second and the another defined symbols.

In one example embodiment, an electronic gaming device is provided. The electronic gaming device may include at least one processor and at least one memory storing (1) reel data defining a plurality of reel strips, each reel strip associated with a respective one of a plurality of columns of symbol positions and (2) instructions which, when executed by the processor, may cause the processor to select, using a random number generator, symbols from a first reel strip for each symbol position of a first column of symbol positions having a base number of symbol positions, select, using the random number generator, symbols from a second reel strip for each symbol position of a second column of symbol positions having the base number of symbol positions, upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions, select, using the random number generator, symbols from at least a third reel strip for each symbol position of a corresponding at least a third column of symbol positions, the at least a third column having the set number of symbol positions, and cause to display on a display device the plurality of columns of symbol positions including the selected symbols.

In another example embodiment, a computer system is provided. The computer may include at least one processor in communication with at least one gaming device and at least one memory storing (1) reel data defining a plurality of reel strips, each reel strip associated with a respective one of a plurality of columns of symbol positions and (2) instructions which, when executed by the processor, may cause the processor to select, using a random number generator, symbols from a first reel strip for each symbol position of a first column of symbol positions having a base number of symbol positions, select, using the random number generator, symbols from a second reel strip for each symbol position of a second column of symbol positions having the base number of symbol positions, upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions, select, using the random number generator, symbols from at least a third reel strip for each symbol position of a corresponding at least a third column of symbol positions, the at least a third column having the set number of symbol positions, and cause to display on the at least one gaming device the plurality of columns of symbol positions including the selected symbols.

In another example embodiment, a method for electronic gaming is provided. The method may be performed by an electronic gaming device including a display, a random number generator, at least one processor, and at least one memory storing reel data defining a plurality of reel strips, each reel strip associated with a respective one of a plurality of columns of symbol positions. The method may include selecting, using a random number generator, symbols from a first reel strip for each symbol position of a first column of symbol positions having a base number of symbol positions, selecting, using the random number generator, symbols from a second reel strip for each symbol position of a second column of symbol positions having the base number of symbol positions, upon determining that the symbols selected for the first and second columns of symbol positions both include a defined symbol of a plurality of defined symbols, setting, for remaining columns, a number of symbol positions by adding a number of symbol positions determined using the random number generator to the base number of symbol positions, selecting, using the random number generator, symbols from at least a third reel strip for each symbol position of a corresponding at least a third column of symbol positions, the at least a third column having the set number of symbol positions, and causing to display on the at least one gaming device the plurality of columns of symbol positions including the selected symbols.

In another example embodiment, at least one non-transitory computer-readable storage media having instructions embodied thereon is provided. When executed by an electronic gaming device including a display, a random number generator, at least one processor, and at least one memory storing reel data defining a plurality of reel strips, each reel strip associated with a respective one of a plurality of columns of symbol positions, the instructions may cause the processor to select, using a random number generator, symbols from a first reel strip for each symbol position of a first column of symbol positions having a base number of symbol positions, select, using the random number generator, symbols from a second reel strip for each symbol position of a second column of symbol positions having the base number of symbol positions, upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions, select, using the random number generator, symbols from at least a third reel strip for each symbol position of a corresponding at least a third column of symbol positions, the at least a third column having the set number of symbol positions, and cause to display on the at least one gaming device the plurality of columns of symbol positions including the selected symbols.

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

What is claimed is:

1. An electronic gaming device comprising:
at least one processor; and
at least one memory storing (1) reel data defining a plurality of reel strips, each reel strip associated with a respective one of a plurality of columns of symbol positions and (2) instructions which, when executed by the processor, cause the processor to:
select, using a random number generator, symbols from a first reel strip for each symbol position of a first column of symbol positions having a base number of symbol positions;
select, using the random number generator, symbols from a second reel strip for each symbol position of a second column of symbol positions having the base number of symbol positions;
upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions;
select, using the random number generator, symbols from at least a third reel strip for each symbol position of a corresponding at least a third column of symbol positions, the at least a third column having the set number of symbol positions; and
cause to display on a display device the plurality of columns of symbol positions including the selected symbols.

2. The electronic gaming device of claim 1, wherein the plurality of columns comprise five columns of symbol positions, and wherein the instructions further cause the at least one processor to:
upon determining that the symbols selected for the third column of symbol positions include a defined symbol of the plurality of defined symbols, set a number of symbol positions for at least a fourth column of symbol positions by determining, using the random number generator whether to add one or more symbol positions to a previously set number of symbol positions to obtain a currently set number of symbol positions; and
select, using the random number generator, symbols from a fourth reel strip for each symbol position of a corresponding fourth column of symbol positions, the fourth column having the currently set number of symbol positions.

3. The electronic gaming device of claim 2, wherein the instructions further cause the at least one processor to:
upon determining that the symbols selected for the third column of symbol positions do not include a defined symbol of the plurality of defined symbols, select, using the random number generator, symbols from a fourth reel strip for each symbol position of a corresponding fourth column of symbol positions, the fourth column having a previously set number of symbol positions.

4. The electronic gaming device of claim 2, wherein the instructions further cause the at least one processor to:
upon determining that the symbols selected for the fourth column of symbol positions include a defined symbol of the plurality of defined symbols, set a number of symbol positions for a fifth column of symbol positions by determining, using the random number generator whether to add one or more symbol positions to a previously set number of symbol positions to obtain a currently set number of symbol positions; and
select, using the random number generator, symbols from a fifth reel strip for each symbol position of the fifth column of symbol positions, the fifth column having the currently set number of symbol positions.

5. The electronic gaming device of claim 2, wherein the instructions further cause the at least one processor to:
upon determining that the symbols selected for the fourth column of symbol positions do not include a defined symbol of the plurality of defined symbols, select, using the random number generator, symbols from a fifth reel strip for each symbol position of a fifth column of symbol positions, the fifth column having a previously set number of symbol positions.

6. The electronic gaming device of claim 2, wherein the first reel strip comprises a first defined symbol, and at least the second, third and fourth reel strips comprise a second defined symbol different from the first defined symbol.

7. The electronic gaming device of claim 6, wherein a fifth reel strip comprises another defined symbol of the plurality of defined symbols different from the first and second defined symbols, and wherein the instructions further cause at least one processor to initiate a feature game upon the selected symbols for the first to fifth columns including, the first, second and the another defined symbols.

8. The electronic gaming device of claim 7, wherein the instructions further cause the at least one processor to, upon the another defined symbol being a third defined symbol, initiate a first feature game.

9. The electronic gaming device of claim 8, wherein the instructions further cause the at least one processor to, upon the another defined symbol being a fourth defined symbol, initiate a second feature game.

10. The electronic gaming device of claim 1, wherein the first reel strip comprises a first defined symbol of the plurality of defined symbols, and at least the second reel strip comprises a second defined symbol of the plurality of defined symbols different from the first defined symbol.

11. An computer system comprising:
at least one processor in communication with at least one gaming device; and
at least one memory storing (1) reel data defining a plurality of reel strips, each reel strip associated with a respective one of a plurality of columns of symbol positions and (2) instructions which, when executed by the processor, cause the processor to:
select, using a random number generator, symbols from a first reel strip for each symbol position of a first column of symbol positions having a base number of symbol positions;
select, using the random number generator, symbols from a second reel strip for each symbol position of a second column of symbol positions having the base number of symbol positions;
upon determining that the symbols selected for the first and second columns of symbol positions both include a defined symbol of a plurality of defined symbols, set, for remaining columns, a number of symbol positions by adding a number of symbol positions determined using the random number generator to the base number of symbol positions;
select, using the random number generator, symbols from at least a third reel strip for each symbol position of a corresponding at least a third column of symbol positions, the at least a third column having the set number of symbol positions; and
cause to display on the at least one gaming device the plurality of columns of symbol positions including the selected symbols.

12. The computer system of claim 11, wherein the plurality of columns comprise five columns of symbol positions, and wherein the instructions further cause the at least one processor to:
upon determining that the symbols selected for the third column of symbol positions include a defined symbol of the plurality of defined symbols, set a number of symbol positions for at least a fourth column of symbol positions by determining, using the random number generator whether to add one or more symbol positions to a previously set number of symbol positions to obtain a currently set number of symbol positions; and
select, using the random number generator, symbols from a fourth reel strip for each symbol position of a corresponding fourth column of symbol positions, the fourth column having the currently set number of symbol positions.

13. The computer system of claim 12, wherein the instructions further cause the at least one processor to:
upon determining that the symbols selected for the third column of symbol positions do not include a defined symbol of the plurality of defined symbols, select, using the random number generator, symbols from a fourth reel strip for each symbol position of a corresponding fourth column of symbol positions, the fourth column having a previously set number of symbol positions.

14. The computer system of claim 12, wherein the instructions further cause the at least one processor to:
upon determining that the symbols selected for the fourth column of symbol positions include a defined symbol of the plurality of defined symbols, set a number of symbol positions for a fifth column of symbol positions by determining, using the random number generator whether to add one or more symbol positions to a previously set number of symbol positions to obtain a currently set number of symbol positions; and
select, using the random number generator, symbols from a fifth reel strip for each symbol position of the fifth column of symbol positions, the fifth column having the currently set number of symbol positions.

15. The computer system of claim 12, wherein the instructions further cause the at least one processor to:
upon determining that the symbols selected for the fourth column of symbol positions do not include a defined symbol of the plurality of defined symbols, select, using the random number generator, symbols from a fifth reel strip for each symbol position of a fifth column of symbol positions, the fifth column having a previously set number of symbol positions.

16. The computer system of claim 12, wherein the first reel strip comprises a first defined symbol, and at least the second, third and fourth reel strips comprise a second defined symbol different from the first defined symbol.

17. The computer system of claim 16, wherein a fifth reel strip comprises another defined symbol of the plurality of defined symbols different from the first and second defined symbols, and wherein the instructions further cause at least one processor to initiate a feature game upon the selected symbols for the first to fifth columns including, the first, second and the another defined symbols.

18. The computer system of claim 17, wherein the instructions further cause the at least one processor to, upon the another defined symbol being a third defined symbol, initiate a first feature game.

19. The computer system of claim 18, wherein the instructions further cause the at least one processor to, upon the another defined symbol being a fourth defined symbol, initiate a second feature game.

20. The computer system of claim 11, wherein the first reel strip comprises a first defined symbol of the plurality of defined symbols, and at least the second reel strip comprises a second defined symbol of the plurality of defined symbols different from the first defined symbol.
